(19) United States
(12) Patent Application Publication
(10) Pub. No.: US 2010/0312158 A1
(43) Pub. Date: Dec. 9, 2010

(54) KNEADING MASSAGE DEVICE

(76) Inventor: PIN-HUNG LIN, Taipei City (TW)

Correspondence Address: LEONG C. LEI, PMB # 1008, 1839 YGNACIO VALLEY ROAD, WALNUT CREEK, CA, 94598, US

(21) Appl. No.: 12/556,600

(22) Filed: Sep. 10, 2009

(30) Foreign Application Priority Data
Jun. 5, 2009 (TW) 098209984

(51) Int. Cl. A61H 7/00

(52) U.S. Cl. 601/134

(57) ABSTRACT

A kneading massage device includes an attachable device body. A drive member and symmetrically arranged rollers are set inside the device body. The drive member is allowed to rotate in a given direction. The rollers are coupled to tracks that are formed in the drive member in a shuttle configuration. The rollers are rotatably and respectively mounted to bands and the bands have ends to which guide pegs are mounted for being movably received in the tracks of the dive member. The device body is selectively attached to a portion of a user's body and the drive member is rotated to have the guide pegs of the bands slide back and forth along the tracks for making the rollers rolling back and forth to effect kneading massaging on the user's body and thus achieve body fitness and losing weight of the user.

### (a) TECHNICAL FIELD OF THE INVENTION

The present invention generally relates to a kneading massage device, and more particularly to a kneading massage device that is attachable to various portions of a user's body to effect kneading massaging on the user's body through back-and-forth rolling of rollers and thus achieve body fitness and losing weight of the user.

### (b) DESCRIPTION OF THE PRIOR ART

With the development of economics and due to the busy living of modern industrial and commercial society, human beings are often lacking of outdoor activities and exercises. This makes most of the modern people fat or corpulent and feeling pain and soar of back and waist. Thus, lots of the modern people use fitness equipments and massage device for exercising and body building. The fitness equipments available in the market provide function of jogging, body stretching, or bike riding. These do not help much in losing weight or removing fat. The known massage devices often have only the function of body massage and provide no reciprocal kneading operation, which is believed to be every effective in losing weight and removing fat. Thus, the known massage devices are not effective in respect of body building and losing weight. In view of this problem, the present invention aims to provide a massage that provides kneading operation in order to achieve the purposes of body fitness and losing weight of the users.

### SUMMARY OF THE INVENTION

The primary objective of the present invention is to provide a kneading massage device that is attachable to various portions of a user's body to effect kneading massage on the user's body through back-and-forth rolling of rollers and thus achieve body fitness and losing weight of the user's body.

In accordance with the present invention, a kneading massage device comprises an attachable device body. A drive member and a plurality of symmetrically arranged rollers are set inside the device body. The drive member is allowed to rotate in a given direction. The rollers are coupled to tracks that are formed in the drive member in a shuttle configuration. The rollers are rotatably and respectively mounted to bands and the bands have ends to which guide pegs are mounted for being movably received in the tracks of the drive member. The device body is selectively attached to a portion of a user's body and the drive member is rotated to have the guide pegs of the bands slide back and forth along the tracks for making the rollers rolling back and forth to effect kneading massaging on the user's body and thus achieve body fitness and losing weight of the user.

In the kneading massage device as described above, two air bags are symmetrically arranged between inside surfaces of the device body and the bands and are connected to a pump, which selectively inflates the air bags to various degrees of inflation for adjusting tightness between the rollers and the user's body.

In the kneading massage device as described above, the drive member comprises a cylindrical cam.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a cross-sectional view of the present invention.

FIG. 4 is a schematic view illustrating the user of the present invention.

FIGS. 5A and 5B are schematic views illustrating operation of the present invention.

FIGS. 6A-6E are schematic views illustrating the operation of a drive assembly of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

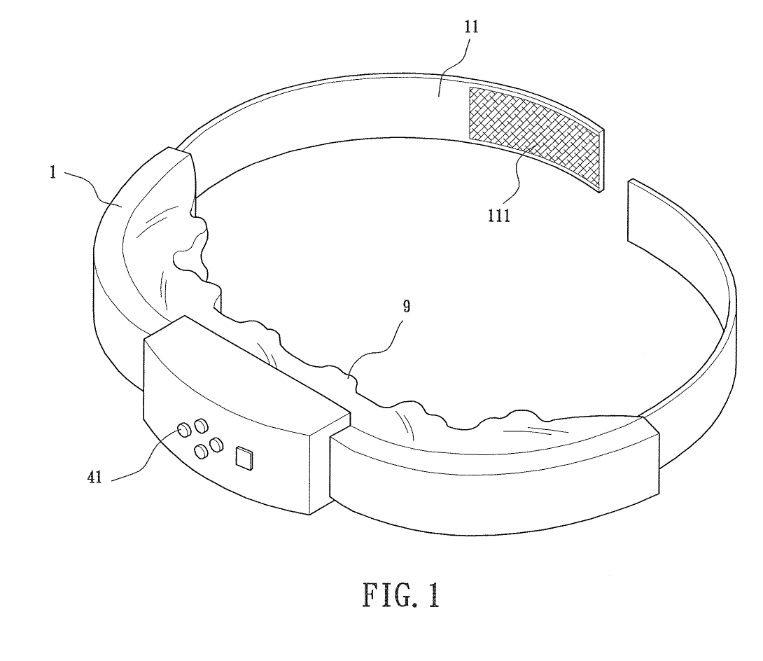

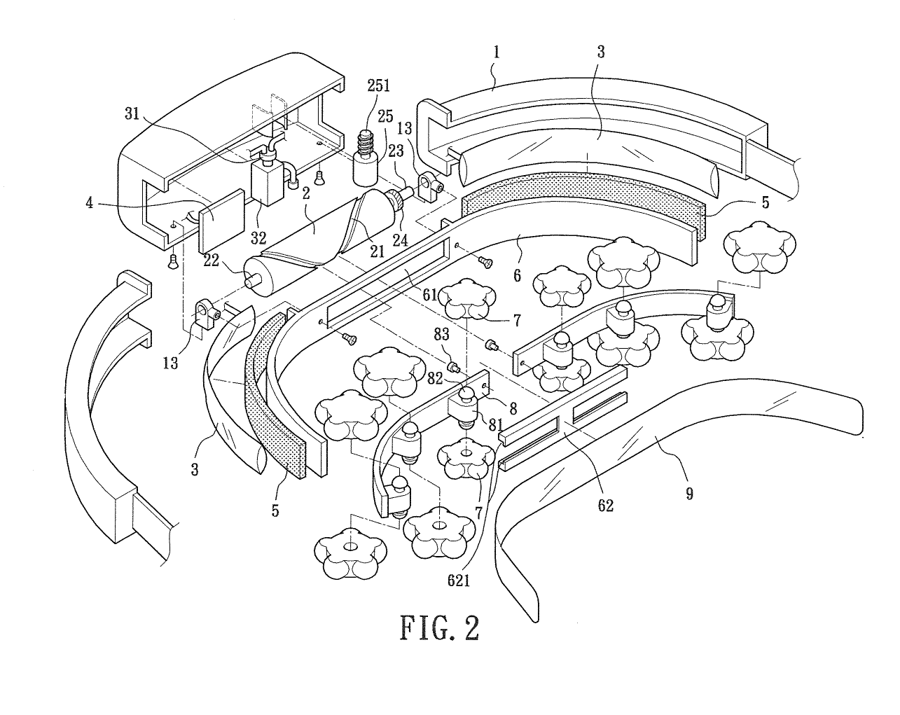

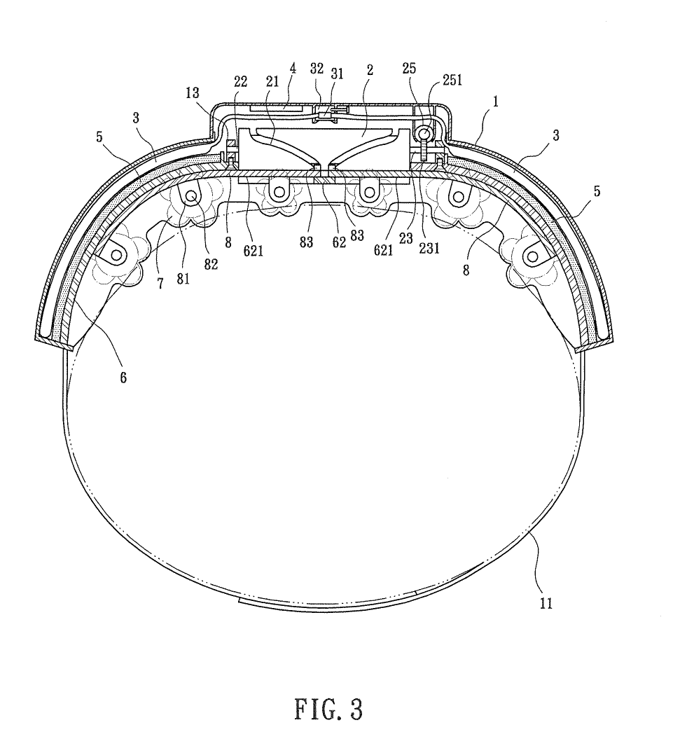

Referring to FIGS. 1-3, which respectively show a perspective view, an exploded view, and a cross-sectional view of a kneading massage device in accordance with the present invention, the kneading massage device of the present invention comprises a device body 1 having two opposite end sections that show a curved configuration. Fastening straps 11 are attached to the two end sections of the device body 1 for fastening to a user's body. The fastening straps 11 have opposing ends on which fastening members 111, such as hook and loop members of Velcro strip, that are engageable with and disengageable from each other are respectively mounted, in order to allow the user to adjust the tightness of the fastening straps 11 fastened to the user's body. The device body 1 receives a drive member 2 therein. The drive member 2 comprises a cylindrical cam having a circumferential surface in which tracks 21, which are arranged in a shuttle-like configuration to get alternately distant from and approaching each other in an axial direction of the cylinder and make the axial distance therebetween alternately and gradually increased and decreased, preferably along curved lotuses, are formed. The drive member 2 has opposite ends respectively forming shafts 22, 23. The shafts 22, 23 are respectively received and retained in support pillars 13 mounted to the device body 1. The shaft 23 is provided with a gear 24 mating a worm 251 mounted to a motor 25.

Two air bags 3 are respectively arranged at two sides of the device body 1 and are coupled to an air nozzle 31, which is in turn connected to a pump 32.

A circuit board 4 comprises a control circuit connected to the motor 25 and the air nozzle 31 and is also provided with a plurality of control buttons 41. These control buttons 41 function to set the rotational speed and the operation time period of the motor 25 and the degree of inflation of the air bags 3 realized by the pump 32.

Two cushioning members 5 are made of soft and flexible materials respectively positioned against the air bags 3. A positioning frame 6 is positioned against the cushioning members 5. The positioning frame 6 defines an opening 61.

A plurality of rollers 7 is set in a symmetric arrangement and is respectively and rotatably mounted to two bands 8. The bands 8 comprise a plurality of spaced brackets 81 each supporting an axle 82. The rollers 7 are respectively and rotatably fit to the axles 82. An end of each band 8 is provided with a guide peg 83, which extends through the opening 61 defined through the positioning frame 6 to be movably received in the corresponding track 21 of the drive member 2.

A board 9 is fixed to the device body 1 and is of flexibility for housing the above discussed components.

The positioning frame 6 comprises a guide 62 having a coupling surface in which two opposite sets of rails 621 are formed. The bands 8 are respectively and movably received in the two sets of rails 621 for positioning and guiding reciprocal movements of the bands 8.

The kneading massage device of the present invention is obtained by assembling the above discussed components together. The device body 1 of the kneading massage device so obtained can be attached to various portions of the user's body with the fastening straps 11, and the rotational speed and operation time period and the degree of inflation can be set through the control buttons 41, so as to allow the actuation of the motor 25 to drive continuous rotation of the drive member 2 in a given direction, causing the guide pegs 83 of the bands 8 to perform reciprocal sliding motion along the tracks 21 of the drive member 2 so as to make the rollers 7 carried by the bands 8 rolling back and forth to perform kneading massage on the user's body and thus achieve the result of body fitness and losing weight of the user.

The air bags 3 of the massage device of the present invention are arranged between inside surfaces of the device body 1 and the cushioning members 5 and are connected to the air nozzle 31 and the pump 32, whereby when in operation, the two air bags 3 can exhibit different degrees of inflation by using the circuit board 4 to control the opening/closing time of the air nozzle 31, in order to realize compressing or releasing applied to the rollers 7 for adjusting the tightness between the rollers 7 and the user's body, eventually making kneading massaging comfortable to the user.

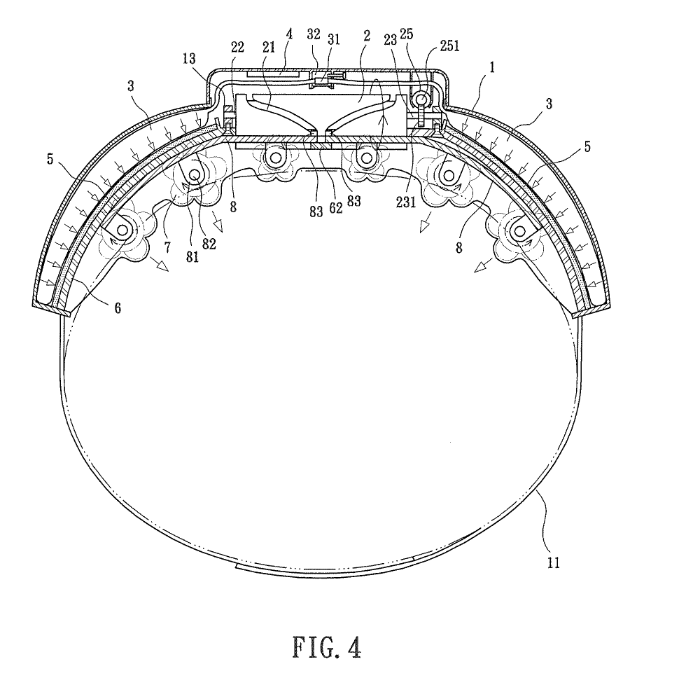

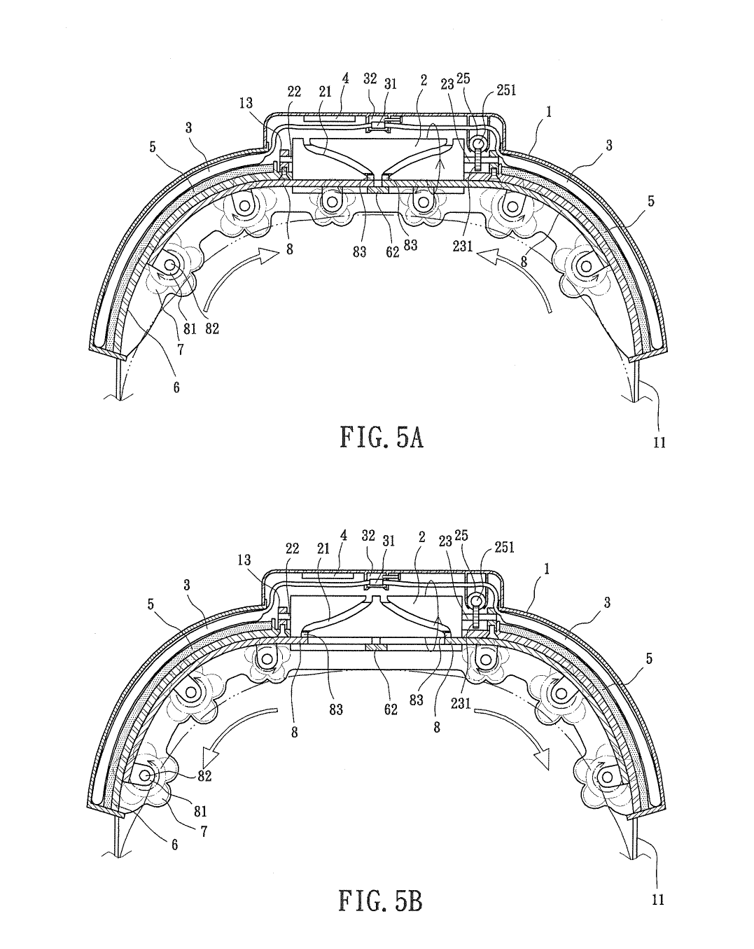

Referring to FIGS. 4, 5A, and 5B, which respective illustrate use and operation of present invention, to put the present invention into operation, the device body 1 of the kneading massage device is selectively attached to various portions of the user's body (such as waist, legs, and heap) through the fastening straps 11. The control buttons 41 are used to set the rotational speed, operation time period, and degree of inflation and then the control buttons 41 are actuated to start the motor 25 to drive continuous rotation of the drive member 2 in a given direction. When the drive member 2 rotates, the guide pegs 83 of the bands 8 are caused to do left-and-right reciprocal movement along the tracks 21 of the drive member 2. Through the guidance provided by the guide 62, the bands 8 reciprocally slides, making the rollers 7 coupled to the bands 8 rolling back and forth, whereby the rollers 7 repeatedly depresses the user's body to effect kneading massaging on the user's body to achieve the result of body fitness and losing weight of the user. During the operation, the circuit board 4 controls the opening/closing time of the air nozzle 31 to inflate the air bags 3 to various degrees for compressing or releasing the rollers 7 so as to adjust the tightness between the rollers 7 and the user's body, or inflate the two air bags 3 to different degrees of inflation for enhancing the effect of kneading massaging.

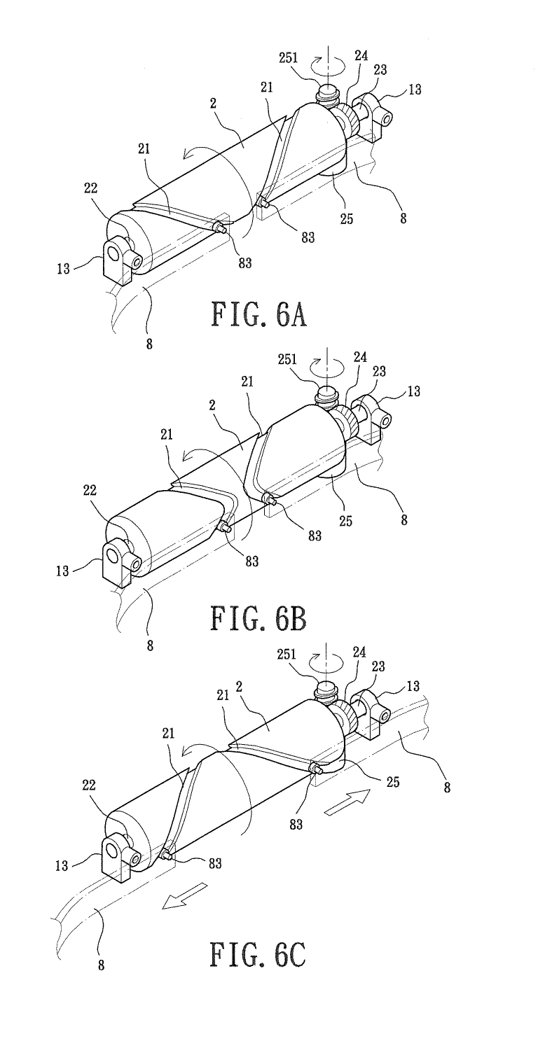

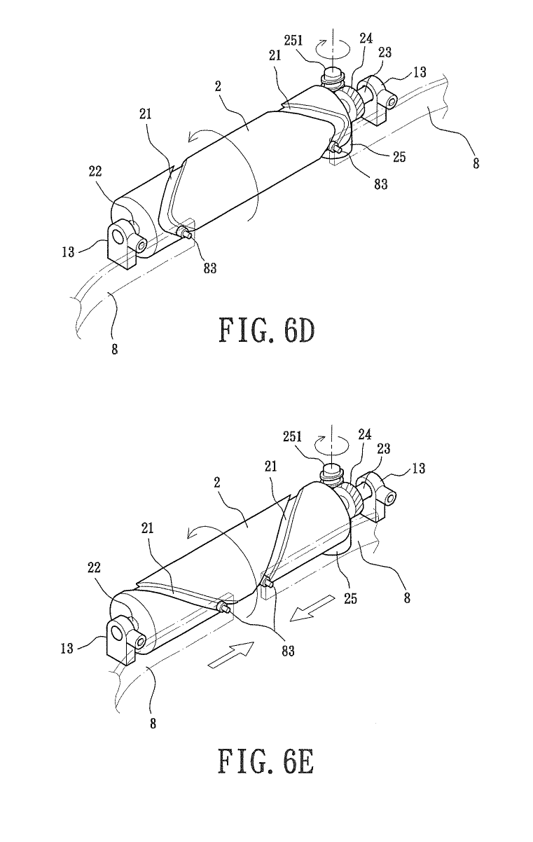

Referring to FIGS. 6A-6D, which illustrate the operation of the drive member 2 of the present invention, together with FIG. 4, after the present invention is actuated, the motor 25 drives the drive member 2 to do continuous rotation in a given direction through the worm 251 and the gear 22. When the drive member 2 rotates, the guide pegs 83 mounted to the ends of the bands 8 are caused to slide back and forth along the tracks 21 of the drive member 2. When the guide pegs 83 approach inner sections of the tracks 21, the bands 8 are brought toward a center of the device body 1 and the rollers 7 are caused to roll toward the center, as shown in FIGS. 6A and 6B. When the guide pegs 83 approach outer sections of the tracks 21, the bands 8 are brought toward opposite axial ends of the device body 1 and the rollers 7 are caused to roll toward the axial ends, as shown in FIGS. 6C and 6D. After a full turn of rotation of the drive member 2, the guide pegs 83 slide to the inner sections of the tracks 21 again and bring the bands 8 toward the center of the device body 1 again, making the rollers 7 rolling toward the center, as shown in FIG. 6E. The operation is carried out in a cyclic manner, allowing the rollers 7 to repeatedly depress the user's body for effecting kneading massaging on the user's body and achieve the result of body fitness and losing weight of the user.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A kneading massage device, comprising an attachable device body and a drive member and a plurality of symmetrically arranged rollers set inside the device body, wherein the drive member has a circumferential surface in which tracks which are arranged in a shuttle-like configuration with axial distance therebetween alternately and gradually increased and decreased are formed, the drive member being driven to rotate in a given direction by a motor, the rollers being respectively mounted to two bands, which have ends to which guide pegs are mounted for being movably received in the tracks of the drive member, whereby the device body is adapted to selectively attach to a portion of a user's body and the drive member is rotated to have the guide pegs of the bands slide back and forth along the tracks for making the rollers rolling back and forth to effect kneading massaging on the user's body and thus achieve body fitness and losing weight of the user.

2. The kneading massage device according to claim 1, wherein the drive member comprises a cylindrical cam.

3. The kneading massage device according to claim 1, wherein the drive member has opposite ends respectively forming shafts, which are respectively received and retained in support pillars mounted to the device body, one of the shafts being provided with a gear mating a worm mounted to a motor.

4. The kneading massage device according to claim 1, wherein the bands to which the rollers are mounted comprise a plurality of spaced brackets each supporting an axle, the rollers being fit to the axles.

5. The kneading massage device according to claim 1, wherein two air bags are symmetrically arranged between inside surfaces of the device body and the bands and are connected to a pump, which selectively inflates the air bags to various degrees of inflation for adjusting tightness between the rollers and the user's body.

6. The kneading massage device according to claim 5, wherein the two air bags are connected to the pump through a nozzle, opening/closing time of the nozzle being controllable to inflate the air bags to different degrees of inflation so as to enhance the effect of kneading massage.

7. The kneading massage device according to claim 1, wherein a circuit board is set inside the device body and comprises a control circuit connected to the motor and the nozzle and is also provided with a plurality of control buttons, which function to set rotational speed and operation time period of the motor and degree of inflation of the air bag.

8. The kneading massage device according to claim 1, wherein the device body has two opposite end sections to which fastening straps are attached, the fastening straps having opposing ends to which fastening members that are engageable with and disengageable from each other are respectively mounted.

9. The kneading massage device according to claim 1, wherein a positioning frame is arranged between an inside surface of the device body and the bands, the positioning frame comprising a guide, which has a coupling surface in which two opposite sets of rails are formed, the bands being respectively and movably received in the rails.
